(19) United States
(12) Patent Application Publication
(10) Pub. No.: US 2008/0016834 A1
(43) Pub. Date: Jan. 24, 2008

(54) Detachable dustproof filtering device

(75) Inventor: Min Lee, Taipei County (TW)

Correspondence Address: TROXELL LAW OFFICE PLLC, SUITE 1404, 5205 LEESBURG PIKE, FALLS CHURCH, VA, 22041, US

(73) Assignee: ARBOR Technology Corp.

(21) Appl. No.: 11/488,658

(22) Filed: Jul. 19, 2006

(51) Int. Cl. B01D 50/00

(52) U.S. Cl. 55/385.6

(57) ABSTRACT

A detachable dustproof filtering device for network chassis is disclosed. The detachable dustproof filtering device includes a detachable filter cover and a filter. The filter cover is a sheet that breaths and its shape is designed according to the shape of the air inlet of the network chassis. By a connecting member, the filter cover is covered on outside of the air inlet while the filter is disposed on inner surface of the detachable filter cover, covering the air inlet completely. Air drawn by a fan passes through the filter first and then enters inner space of the chassis so that space inside the chassis keeps clean even being used for quite a long time.

### BACKGROUND OF THE INVENTION

The present invention relates to a detachable dustproof filtering device, especially to a detachable dustproof filtering device that is arranged on an air inlet of a network chassis and is able to be assembled or detached without turning off the network appliances. Thus air flowing inside the network chassis keeps extremely clean after long-term use.

Network communication such as internet telephone, internet shopping, internet education is quite popular today. There are always a lot people hanging on line all the time, all over the world. In order to provide service, network host inside the chassis is turned on a whole year. For heat dissipation, the network host/chassis is disposed with heat sinks and a corresponding air inlet. Thus air is driven to flow into the network host/chassis through the air inlet and then is exhausted through an air outlet for bringing out heat generated by electronic components therein.

Therefore, the chassis provides a good environment for operation of the host so as to keep the network host in high efficiency. However, a conventional network host/chassis is only disposed with gate-type or slot-type air inlet without any filter for dustproof purpose. Although there may be air conditioner in a machine room, it's difficult to avoid curd or dust settled inside the chassis through the air inlet after long-term use. Moreover, general network hosts need to be turned off and then open a housing of the chassis for cleaning/dust elimination. This cause users trouble and the related procedures are quite complicated. Thus there is a space for improving shortcomings of air inlets of conventional network chassis.

### SUMMARY OF THE INVENTION

Therefore it is a primary object of the present invention to provide a detachable dustproof filtering device composed of a filter cover and a filter. The filter cover is designed according to shape of the air inlet of the network chassis for easy assembling on outside of the air inlet while the filter is arranged on inner surface of the filter cover for covering the whole air inlet completely. In usage, air from outside environment passes through the filter firstly and then enters inner space of the chassis. Thus inner space of the chassis keeps cleaning after long-term use. Furthermore, there is no need to shut down the network host, the filter cover can be assembled or detached directly for replacing the filter. Therefore, the device is easy to operate with ideal dust-proof effect.

### BRIEF DESCRIPTION OF THE DRAWINGS

FIG. 1 is a perspective view of an embodiment according to the present invention;

FIG. 2 is a partial enlarged view of the embodiment in FIG. 1;

FIG. 3 is an explosive view of an embodiment according to the present invention;

FIG. 4 is a partial enlarged view of the embodiment in FIG. 3.

### DETAILED DESCRIPTION OF THE PREFERRED EMBODIMENT

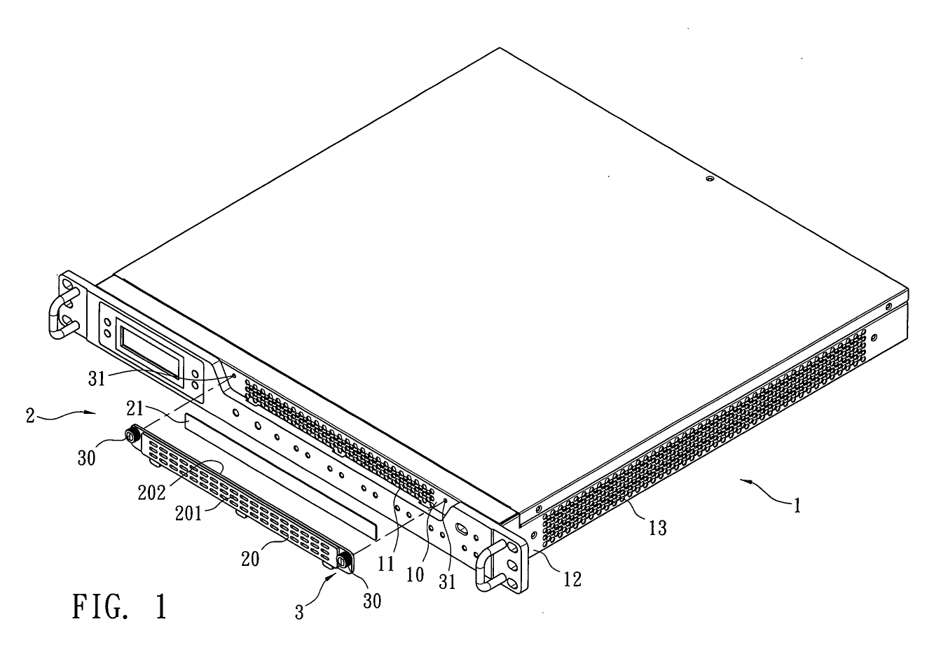

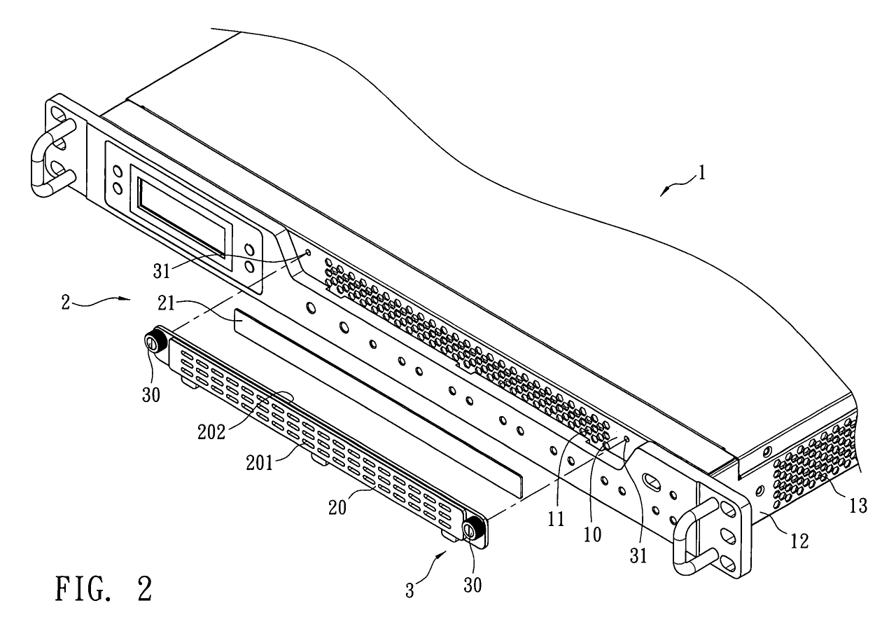

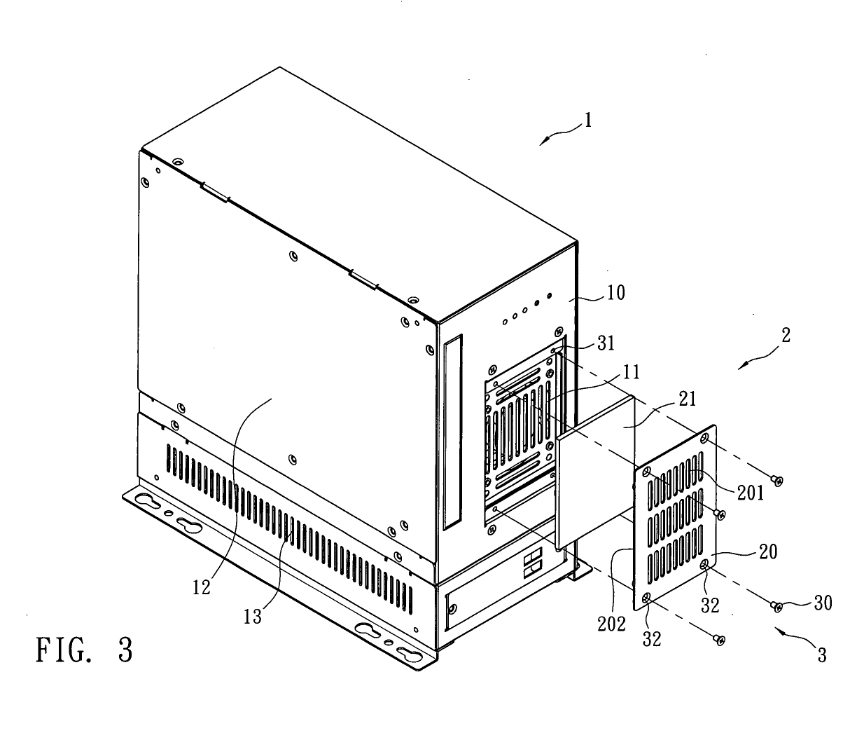

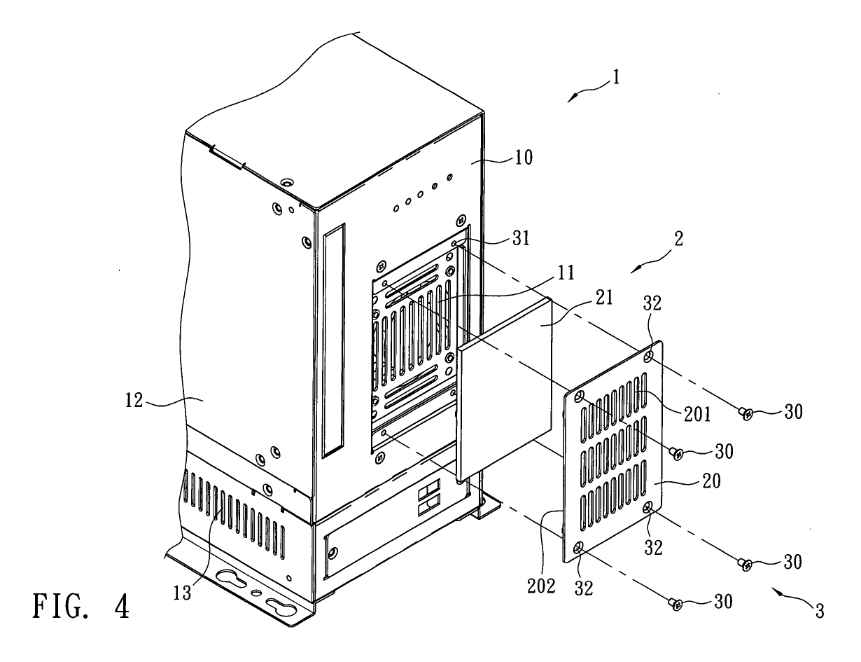

The most common chassis is a flat-type, as shown in FIG. 1 & FIG. 2 or a cubic chassis, as shown in FIG. 3 & FIG. 4. Generally, a fan for heat dissipation (not shown in figure) is disposed inside a chassis, near inner surface of a housing (front side, rear side or lateral side). An air inlet 11 is disposed on the housing 10 (front side, rear side or lateral side), corresponding to the fan, as shown in FIG. 1 & FIG. 3. Air is driven by the fan for heat dissipation, flowing into inner space of the chassis 1 through the air inlet 11. Then the air is exhausted through an air outlet 13 arranged on other side of the housing 12. As shown in FIG. 1 & FIG. 3, the air outlet 13 is always disposed on left and right sides of the housing 12. Thus heat generated from electronic components inside the chassis 1 is carried out by the air. Therefore, inner space of the chassis 1 provides a good environment for operation of the network host and the network host works with high efficiency.

The present invention features on that a detachable dustproof filtering device 2 is arranged on outside of the air inlet 11 on the network chassis 1. The detachable dustproof filtering device 2 consists of a filter cover 20 and a filter 21. The filter cover 20 is a sheet that breaths and the shape of the filter cover 20 is designed according to the shape of the air inlet 11 of the network chassis 1 so as to make the filter cover 20 attach and cover on outside of the air inlet 11 by a connecting member 3. At least one air vent 201 for better airflow is disposed on the filter cover 20. The filter 21 is set on inner surface 202 of the filter cover 20 so that the filter 21 covers the air inlet 11 completely when the filter cover 20 is assembled outside the air inlet 11. Thus external air driven by the fan for heat dissipation passes through the filter 21 on inner surface 202 of the filter cover 20 firstly, and then enters inner space of the chassis 1. Dust or crud in the air is removed by the device. Therefore, even being used for a long time, space inside the chassis 1 can still keep cleaning. Furthermore, under the condition that the network host inside the chassis 1 is not off, the filter cover 20 is directly assembled or detached for replacement of the filter 21. The device is easy to use and to have dustproof effect.

Refer to FIG. 2 & FIG. 4, a connecting member 3 is disposed between the filter cover 20 and outside surface of the air inlet 11 so as to make the filter cover 20 easily assembled on outside of the air inlet 11. There is no limitation on connecting way of the connecting member 3. For example, it can be threading or mounting. As shown in figure, the connecting member 3 includes a plurality of fastening members 30 such as screws and corresponding holes 31. The filter cover 20 is disposed on outside of the air inlet 11 by the fastening members 30 being threaded into the corresponding holes 31 outside the air inlet 11. Moreover, the fastening members 30 can be integrated with the filter cover 20, as shown in FIG. 1 & FIG. 2. Or a plurality of holes 32 is arranged on the filter cover 20 for being inserted with the fastening members 30. Therefore, the filter cover 20 outside the air inlet 11 is easy to be assembled or detached. The present invention is easy and convenient to use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A detachable dustproof filtering device disposed outside an air inlet of a network chassis comprising a detachable filter cover and a filter; wherein
the filter cover is a sheet with air vents the shape of the filter cover is designed according to the shape of the air inlet of the network chassis so as to make the filter cover attach on outside of the air inlet by a connecting member;
the filter is arranged on inner surface of the filter cover for covering the air inlet completely while the filter cover arranging outside the air inlet;
external air flows into the chassis through the air inlet, passes the filter on inner surface of the filter cover first and then enters inner space of the chassis so as to filter dust and cruds on air and space inside the chassis keeps clean after long-term use.

2. The device as claimed in claim 1, wherein the connecting way between the filter cover and the outer surface of the air inlet is not limited.

3. The device as claimed in claim 1, wherein the connecting member comprising a plurality of fastening members threaded into corresponding holes of the air inlet so as to secure the filter cover on outside of the air inlet.
